(19) United States
(12) Patent Application Publication
(10) Pub. No.: US 2018/0315088 A1
(43) Pub. Date: Nov. 1, 2018

(54) RECOMMENDATION ENGINE FOR GENERATING CONTEXT-SPECIFIC RECOMMENDATIONS

(71) Applicant: Uber Technologies, Inc., San Francisco, CA (US)

(72) Inventors: Rahul Bijor, San Francisco, CA (US); Andrew Quinn, San Francisco, CA (US)

(21) Appl. No.: 15/582,228

(22) Filed: Apr. 28, 2017

(51) Int. Cl. G06Q 30/02; G06Q 10/10; G06Q 50/00

(52) U.S. Cl. CPC G06Q 30/0261; G06Q 30/0269; G06Q 50/01; G06Q 10/1093

(57) ABSTRACT

A network system for managing network services over a given geographic area includes a recommendation engine for generating recommendations and/or promotions based on context information. Context information can include information relating to a user maintained or stored by the network system. Context information can further include information relating to a service requested by the user. In addition, context information can include information received from third-party sources such as an establishment visited by the user, a calendar service, or a financial transaction service. Based on the context information, the recommendation engine can select appropriate promotions and generate suitable recommendations for the user. In doing so, the recommendation engine can deliver particularly suitable promotions and/or recommendations at times the user is able to take action on the promotions and/or recommendations. In addition, the recommendation engine can determine whether the user fulfilled requirements of a selected promotion.

### BACKGROUND

Known recommendation systems can generate content relating to recommendations and promotions for restaurants, bars, and the like to a user based on the user's current location. For instance, such recommendation systems can deliver recommendations for restaurants located within a certain radius of the user's current location. However, such recommendations, based only on the user's current location, are often inappropriate or unsuitable for the user. For instance, the user may be taking a mode of transportation to another location. Thus, recommendations generated based on the user's current location may not be relevant by the time the user has the opportunity to view and take action on the recommendations. Furthermore, the generation of such recommendations also do not take into account other circumstances faced by the user.

### BRIEF DESCRIPTION OF THE DRAWINGS

The disclosure herein is illustrated by way of example, and not by way of limitation, in the figures of the accompanying drawings in which like reference numerals refer to similar elements, and in which:

FIG. 1 is a block diagram illustrating an example network system having a recommendation engine that is in communication with user and provider devices, in accordance with examples described herein;

FIG. 2 is a flow chart describing an example method of operating an exemplary network system having a recommendation engine, according to examples described herein;

FIG. 3 is a block diagram illustrating an example user device executing and operating a designated user application for communicating with a network service, according to examples described herein; and

FIG. 4 is a block diagram that illustrates a computer system upon which examples described herein may be implemented.

### DETAILED DESCRIPTION

A network system is provided herein that manages an on-demand service linking service providers (e.g., drivers, couriers, autonomous vehicles (AVs), etc.) with requesting users throughout a given geographic region (e.g., a metroplex such as the San Francisco Bay Area). The network system can manage a pool of service providers over the given geographic region, each operating a computing device (“provider devices”). In doing so, the network system can receive service requests from riders via a designated user application executing on the users' mobile computing devices (“user devices”). The requested service can correspond to an on-demand transportation service, a delivery service, and the like. In response, the network system can identify one or more candidate service providers from the pool of service providers and transmit invitations to provider devices of the candidate service providers to invite the candidate service providers to fulfill the request for service. Upon receiving the invitation, the provider devices can display information relating to the request for service and the candidate service providers can choose to accept or reject the invitation via a designated driver application executing on the driver devices. The driver devices transmit the responses to the network system. In response, the transport facilitation system can select one of the candidate service providers to fulfill the request for service.

In various aspects, the request for service can indicate a start location (e.g., a location at which the service provider is to rendezvous with the requesting user, a pickup location) and a service location (e.g., a location at which the requested service is completed, a drop-off location). Both locations can be entered by the requesting user as addresses, as names of entities (e.g., restaurants, bars, retailers, venues, etc.) or as cross streets. In addition, the requesting user can interact with a map interface provided within the user application to set the start and service locations. Furthermore, the start location can be determined programmatically by the user device based on real-time location data generated by the user device (e.g., by a GPS subsystem of the user device). In this manner, the requesting user can set his or her current location as the start location. In addition, the request service can indicate a service time corresponding to a desired time at which the requested service is to be initiated or completed.

Examples described herein provide for the network system to include a recommendation engine capable of utilizing context information associated with a user and the user's request for service to deliver appropriate and suitable promotions and/or recommendations. In these discussions, context can refer to the circumstances regarding the user and the user's request for service. Thus, as used herein, context information can include information derived from the user's profile (e.g., home location, office location, favorite destinations, personal preferences, etc.), information derived from historical data (e.g., user's past services), information relating to other users of the network service (e.g., data regarding user behavior), information received from third party sources (e.g., a calendar service, a reservation service, a financial transaction service, etc.). Context information can also be derived from the user's request for service (e.g., service location, service time, class of service, etc.). In addition, context information can include information pertaining to other users of the network system, including one or more additional users serviced by the service provider in response to the service request from the requesting user. According to embodiments, the recommendation engine can select suitable recommendations from a plurality of available promotions based on context information. The recommendation engine can retrieve data pertaining to available promotions from a database, which can be maintained by the network system or by a third-party service.

As used herein, promotions can refer to any offers or benefits to encourage user activity or behavior. Promotions can include discounts or offers at an entity or an establishment. Promotions can also correspond to a discount or benefit associated with the service managed by the network system (e.g., an on-demand transportation service, an on-demand delivery service, etc.). Promotions can include requirements needed to obtain the stated benefits, such as a spending requirement. One example promotion can be an offer of $20 off $40 at a restaurant. As used herein, recommendations can refer to any suggestions or information relating to entities that may be of interest to the user. The terms promotions and recommendations can be used interchangeably herein.

According to some examples, the context information utilized by the recommendation engine to determine appropriate promotions for the user includes a service location associated with the service request. Thus, the recommendation engine can determine appropriate recommendations based on the service location indicated in the requesting user's service request. In the context of an on-demand transportation service, the service location can be a drop-off location at which the service provider is to drop off the requesting user to fulfill the requested on-demand transportation service. The recommendation engine can select, for the user, promotions offered by entities (e.g., restaurants, venues, retailers) located within a certain distance of the service location.

In some implementations, the context information can include a time associated with the service request. Promotions can be determined based on a time the requested service is to be performed. For example, promotions or recommendations suitable for evenings (e.g., dinner recommendations) can be selected from available promotions or recommendations based on the service request indicating that the requested service is to be performed at 7:00 PM. In addition, the recommendation engine can also select promotions based on the day the of the week; some promotions may only be available or applicable on certain days of the week. In addition, the recommendation engine can determine appropriate promotions based on service progress information related to the requested service, such as an estimated time of completion of the requested service. Thus, in the context of an on-demand transport service, for example, the network system can determine an estimated time of arrival (ETA) at a drop-off location (e.g., where the service provider drops off the requesting user to complete the requested service) for the requested user. The recommendation engine can select appropriate promotions for the requesting user based on the ETA at the drop-off location. For instance, the recommendations engine can determine, based on the ETA, which of the available promotions are unavailable or inapplicable at or around the ETA at the drop-off location. For example, some of the available promotions may be offered by entities that are closed (e.g., outside of operating hours) at or around the ETA at the drop-off location. Thus, the recommendation engine can unselect or remove unavailable or inapplicable promotions in determining the appropriate promotions for the requesting user based on the ETA information.

In some examples, the context information can further include a class of service requested by the requesting user. For example, in the context of an on-demand transportation service, the promotions identified by the recommendation engine as being suitable for the requesting user may depend on whether the requesting user requested a basic ride-pooling service as compared with a luxury transportation service. If the requesting user requests a luxury transportation service, the recommendation engine can select promotions having a high spending requirement or promotions offered by high-end entities. The recommendation engine can also generate recommendations relating to high-end entities. If the requesting user requests a basic ride-pooling or an economy transport service, the recommendation engine can determine to select promotions having lower spending requirements.

According to some implementations, context information can include information derived from data pertaining to the requesting user or the requesting user's past use of the network service. For example, context information can include information relating to preferences of the user or as indicated in the user's profile data. The user's profile data can indicate, for example, that the user has preferences for a particular type of retailer or a particular genre of restaurants (e.g., based on past service requests requesting transport services to retailers of the particular type, based on user input, etc.). Based on such profile data, the recommendation can select promotions or generate recommendations for the user that reflect the user's preferences. User profile data can further indicate the user's demographic information that can be used to select promotions. For instance, promotions can be selected for the user based on the user's home location, work location, etc. In addition, context information can further include information derived from historical data maintained by the network system relating to past service requests of the users, such as past service locations. As one example, frequent service locations indicated in past service requests submitted by the user can be used to determine promotions for the users. In addition, if a user frequently requests a delivery service from a particular entity (e.g., a restaurant), the recommendation engine can select promotions offered by or related to the particular entity to the user based on the user's past requests for delivery service. Similarly, if the user frequently requests a transport service to the location of a restaurant, the recommendation engine can select promotions offered by or related to the restaurant based on the user's past requests for the transport service.

In some examples, context information can further include information derived from data received from third-party sources. Such third-party sources can include calendar services, social media services, reservation services (e.g., a restaurant booking service, an event reservation service), concierge services, etc. In one instance, the context information can include information regarding one or more upcoming or past appointments of the requesting user based on data received from a calendar service hosting the requesting user's calendar data. In another example, the context information can include information derived from a social media source (e.g., social media postings of the user). Furthermore, context information can be derived from transaction or purchase data received from a third-party source (e.g., credit/debit card processors, credit/debit card issuers, payment networks, point of sales terminals, etc.).

In an example, the context information can further include location data of the requesting user. For instance, the user application can cause the user device to collect location data after the completion of the requested service (e.g., five minutes after the completion of the requested service). In the context of an on-demand transport service, the user device can collect and transmit location data to the network system for a limited period of time (e.g., five minutes) after the service provider drops off the requesting user at the service location. Such collected location data can be transmitted to the recommendation engine and used to determine appropriate promotions and recommendation for the requesting user.

According to embodiments, the context information can further include information pertaining to one or more additional users serviced by the service provider in response to the service request from the requesting user. For example, in the context of an on-demand transportation service, the request from the requesting user can indicate an intermediate location to pick up one or more other users of the network service en-route to a service location (e.g., a drop-off location). In response to the request for service, the recommendation engine can select promotions for the requesting user and the one or more additional users based on information pertaining to the one or more other users, including preferences of the one or more users as indicated by user profile data of the one or more users. The network system can transmit content data pertaining to the selected promotions to devices of the one or more additional users in addition to the device of the requesting user.

In the examples described herein, the recommendation engine can determine an intended destination based on the context information to determine appropriate promotions and/or recommendations for the requesting user. As used herein, the intended destination can be an entity (e.g., a restaurant, a retailer, a venue, etc.) visited or to be visited by the user before or after the requested service. For instance, based on context information, the recommendation engine can determine whether the user intends to visit an entity at or near the service location after the completion of the requested service. In one example, the recommendation engine can recognize that the user entered the address or the name of the entity (e.g., restaurant name) as the service location when requesting the transport service. In response, the recommendation engine can identify the entity as the intended destination for the requested service. In another example, the user can enter a cross-street or a coordinate (e.g., longitude and latitude) as the service location for the transport service. The recommendation engine can identify nearby entities by, for example, querying a database for all entities within a certain distance from the service location. The recommendation engine can determine one or more of the nearby entities to be the intended one or more destinations based on temporal information, historical data, user profile data, and/or other context information.

The recommendation engine can determine an intended destination based on transaction data of the user (e.g., transaction data indicating a purchase at an entity). In an example, the network system can receive transaction data indicating the requesting user's transaction(s) at an entity. By analyzing the transaction data and other context information, the recommendation engine can determine whether the entity is an intended destination of the requesting user. For instance, if the transaction data indicates that the user's transaction occurred around the time of the requested service (e.g., at or around a time of service completion) and near the service location, the recommendation engine can determine the entity to be an intended destination of the requesting user. The recommendation engine can further determine an intended destination of the requesting user based on data received from a calendar service or a reservation service. For example, if data received from the calendar service or the reservation service indicates that the requesting user has an upcoming appointment or an upcoming reservation at an entity near the service location, the recommendation engine can determine the entity to be the intended destination of the requesting user.

In various aspects, the recommendation engine can further determine a potential point of interest based on the context information to determine appropriate promotions and/or recommendations for the requesting user. As used herein, a point of interest can refer to entities that may be of interest to the user after the user's visit to the intended destination is complete. As one example, the recommendation engine can determine that the requesting user's intended destination is a restaurant. Based on various context information (e.g., temporal information, user profile information, location information), the recommendation engine can determine that a dessert shop is a potential point of interest for the user after the user is complete with his or her visit to the restaurant.

According to embodiments, the recommendation engine can select promotions and generate recommendations based on historical data maintained by the network system. Historical data can indicate trends and typical behavior or preferences of users of the network services based on a particular set of context information and such information can be leveraged to select suitable promotions or generate appropriate recommendations for a requesting user having similar context information. As one example, historical data can indicate that users visiting a particular restaurant typically visit a dessert shop nearby after completing the visit to the restaurant. Based on such historical data, the recommendation engine can select promotions relating to the dessert shop for the requesting user in response to determining that requesting user's intended destination associated with a service request is the particular restaurant. As another example, historical data can also indicate that users requesting a transport service to a certain geographic region (e.g., a particular neighborhood) during a certain time interval (e.g., between 7:00 to 9:00 PM) frequently visit a particular entity. Thus, based on such historical data, the recommendation engine can select promotions relating to the particular entity for the requesting user when context information indicates that the user will be located within the certain geographic region during the certain time interval. In such implementations, machine-learned models (e.g., neural networks, decision trees, etc.) can be generated based on historical data and used to select suitable promotions for the requesting user based on context information associated with the requesting user.

According to embodiments, the network system can generate content data corresponding to the one or more recommendations and promotions selected by the recommendation engine. The content data can be transmitted to the user device to cause the user device, via the user application, to display content regarding the one or more recommendations and promotions. In addition, the recommendation engine can further transmit data to the user device to cause the user device to display a push notification regarding the promotions selected for the user.

In certain implementations, the recommendation engine can further determine a delivery time for the generated content data. The delivery time can indicate a time at which the network system is to transmit the generated content data to the user device. The delivery time can be determined based on context information and the selected promotion (or generated recommendation) for which the content data was generated. In this manner, the selected promotion or generated recommendation can be optimally conveyed to the user at a time when the user is able to take action on the promotion or recommendation. As one example, the delivery time can be determined based on service progress information determined by the network system for the requested service. For instance, the network system can determine an ETA of the requesting user at a service location (e.g., drop-off location) for a requested transport service. Based on the ETA information, the recommendation engine can determine a delivery time of content data pertaining to promotions offered by entities located near the service location. Thus, the requesting user can be presented with the promotions before or around the same time as when the requesting user arrives at the service location. In this manner, the requesting user is presented with the promotions at an optimal time when the requesting user can take action on the promotions. As another example, context information can indicate that the requesting user is visiting a restaurant and the selected promotion relates to an additional point of interest for the requesting user such as a dessert shop that the user may be interested in visiting after his or her visit to the restaurant is complete. Based on such context information, the recommendation engine can estimate when the requesting user will complete his or her visit to the restaurant (e.g., based on average time patrons spend at the particular restaurant etc.) and deliver content data for the selected promotion at that time. As an alternative, the content data can be transmitted to the user device and cached so as to be displayed to the user at an appropriate time.

In some examples, after generating and transmitting content data pertaining to a selected promotion to the requesting user's device, the recommendation engine can further determine whether the requesting user fulfilled one or more requirements of the selected promotion. The one or more requirements of the selected promotion can be a fixed spending requirement, a requirement related to a number of transactions at an entity, a requirement related to a number of items purchased at an entity, and the like. The recommendation engine can determine fulfillment of the one or more requirements based on transaction data received from a financial service (e.g., a credit/debit card processor or issuer) or data received from the entity offering the promotion (e.g., data from a point of sale terminal at the entity offering the promotion). In certain implementations, a benefit of the selected promotion can be related to the network service. After fulfilling the one or more requirements of the selected promotion, a benefit can be given to the requesting user for use with the network service. For instance, after fulfilling a spending requirement at a bar, the user can be given a credit to be applied for a request for an on-demand transportation service. The benefit related to the network service can further be geo-fenced and time-bound. Thus, the credit received by the requesting user for fulfilling the spending requirement at the bar can be limited to a certain time (e.g., at or around closing time of the bar) and a certain drop-off location (e.g., home location of the requesting user).

Among other benefits, the network system and the recommendation engine described herein allow for delivery of highly individualized and customized promotions and recommendations that are particularly relevant and suitable for the user based on context information determined from a variety of sources, including the user's service request. By taking into account context information and generating relevant promotions, the network system and recommendation engine provide tangible improvements in delivering content to the user compared with conventional approaches. In particular, the network system and recommendation engine can more optimally utilize processing resources, networking bandwidth, and user device display real estate by delivering, at the appropriate times, suitable and relevant promotions and recommendations and avoiding those that may be irrelevant or unsuitable for the user based on various context information.

As used herein, a computing device refers to devices corresponding to desktop computers, cellular devices or smartphones, personal digital assistants (PDAs), laptop computers, virtual reality (VR) or augmented reality (AR) headsets, tablet devices, television (IP Television), etc., that can provide network connectivity and processing resources for communicating with the system over a network. A computing device can also correspond to custom hardware, in-vehicle devices, or on-board computers, etc. The computing device can also operate a designated application configured to communicate with the network service.

One or more examples described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers, desktop computers, cellular or smartphones, personal digital assistants (e.g., PDAs), laptop computers, VR or AR devices, printers, digital picture frames, network equipment (e.g., routers) and tablet devices. Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples disclosed herein can be carried and/or executed. In particular, the numerous machines shown with examples of the invention include processors and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer programs, or a computer-usable carrier medium capable of carrying such a program.

Some examples are referenced herein in context of an autonomous vehicle (AV) or self-driving vehicle (SDV). An AV or SDV refers to any vehicle which is operated in a state of automation with respect to steering and propulsion. Different levels of autonomy may exist with respect to AVs. For example, some vehicles may enable automation in limited scenarios, such as on highways, provided that drivers are present in the vehicle. More advanced AVs can drive without any human assistance from within or external to the vehicle. Such vehicles are often required to make advanced determinations regarding how the vehicle behaves given challenging surroundings of the vehicle environment.

System Descriptions

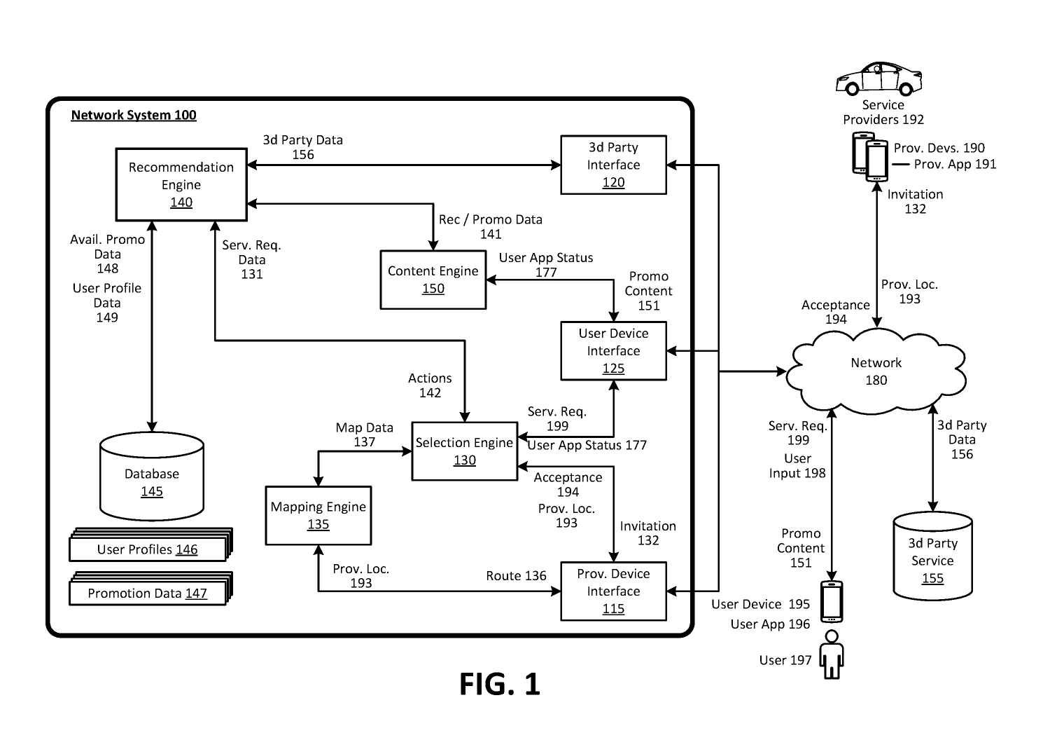

FIG. 1 is a block diagram illustrating an example network system having a recommendation engine that is in communication with user and provider devices, in accordance with examples described herein. The network system 100 can manage a network service that connects requesting users 197 with service providers 192 that are available to service the users' service requests 199. The network service can provide a platform that enables on-demand services (e.g., a transportation service, a ride-sharing service, a delivery service, etc.) between a requesting user 197 and available service providers 192 by way of a user application 196 executing on the user devices 195, and a service provider application 191 executing on the provider devices 190. As used herein, a user device 195 and a provider device 190 can comprise a computing device with functionality to execute a designated application corresponding to the network service managed by the network system 100. In many examples, the user device 195 and the provider device 190 can comprise mobile computing devices, such as smartphones, tablet computers, VR or AR headsets, on-board computing systems of vehicles, smart watches, and the like.

The network system 100 can include a user device interface 125 to communicate with user devices 195 over one or more networks 180 via a user application 196. According to examples, a requesting user 197 wishing to utilize the network service can launch the user application 196 and transmit a service request 199 over the network 180 to the network system 100. In certain implementations, the requesting user 197 can view multiple different service types managed by the network system 100, such as a basic ride-share service, an economy service, a luxury service, a professional service provider service (e.g., where the service provider is certified), a self-driving vehicle transport service, and the like. The network system 100 can utilize the service provider locations 193 to provide the user devices 195 with ETA data of proximate service providers for each respective service. For example, the user application 196 can enable the user 197 to scroll through each service type. In response to a soft selection of a particular service type, the network system 100 can provide ETA data on a user interface of the user app 196 that indicates an ETA of the closest service provider for the service type, and/or the locations of all proximate available service providers for that service type. As the user scrolls through each service type, the user interface can update to show visual representations of service providers for that service type on a map centered around the user 197 or a start location set by the user. The user can interact with the user interface of the user application 196 to select a particular service type, and transmit a service request 199.

In certain implementations, the user device interface 125 can receive user input 198 and user application status 177 from the user devices 195 over the network 180. User interactions with the user application 196, including with any content displayed therein, can be transmitted as user inputs 198. Such inputs can include selections, text inputs, swipes, gestures, uploads, and the like. User application status 177 can correspond to signals or data indicating a status of the user application 196. For instance, when the user 197 first opens the user application 196, the user application 196 can cause the user device 195 to transmit a synchronization signal indicating that the user application is open.

In some examples, the service request 199 can include a start location within a given region (e.g., a metropolitan area managed by one or more datacenters corresponding to the network system 100) at which a matched service provider 192 is to rendezvous with the requesting user 197. The start location can be inputted by the user by setting a location pin on a map interface of the user application 196, or can be determined by a current location of the requesting user 197 (e.g., utilizing location-based resources of the user device 195). Additionally, the requesting user 197 can further input a service location during or after submitting the service request 199.

In various implementations, the network system 100 can further include a selection engine 130 to process the service requests 199 in order to identify one or more service providers 192 to service the service request 199. The network system 100 can include a provider device interface 115 to communicate with the provider devices 190 via the service provider application 191. In accordance with various examples, the provider devices 190 can transmit real-time location information using geo-aware resources of the provider devices 190 (e.g., GPS or GLONASS). These service provider locations 193 can be utilized by the selection engine 130 to identify a set of candidate service providers 192 that can service the service request 199. The set of candidate service providers 192 can be identified based on an ETA to the service location, a service type, a provider type (e.g., luxury service provider, economy service provider), etc. In certain implementations, the network system 100 can also identify an autonomous vehicle (AV) to service the service request 199. Thus, the pool of proximate candidate service providers in relation to a start location can also include one or more AVs operating throughout the given region.

Once one or more candidate service providers 192 are identified by the selection engine 130, the selection engine 130 can generate invitations 132 to each of the one or more candidate service providers 192. Upon receiving the invitations 132, the one or more candidate service providers 192 can accept or decline the invitations 132 via the service provider application 191. Upon receiving acceptances 194 from the provider devices 190, the selection engine 130 can select one of the candidate service providers 192 who submitted an acceptance to fulfill the service request 199.

In some aspects, the network system 100 can include a mapping engine 135, or can utilize a third-party mapping service, to generate map data 137 and or traffic data in the environment surrounding the start location. The mapping engine 135 can receive the service provider locations 193 and input them onto the map data 137. The map data 137 can be utilized by the selection engine 130 to identify the one or more candidate service providers 192 that are located near the start location. In addition, the mapping engine 130 can generate a route 136, including turn-by-turn directions, for transmission to the service provider 192 selected to fulfill the service request 199. The route 136 can include route segments from the current location of the service provider 192 to the start location, from the start location to the service location, etc. The route 136 can further include route guidance to intermediary stops for certain service requests (e.g., intermediate stop to pick up or drop off another ride sharing passenger).

In various implementations, the network system 100 can further include a database 145 storing user profiles 146 including historical information specific to the individual users 197 of the on-demand network service. Such information can include user preferences of service types, routine routes, start locations, service locations, work addresses, home addresses, addresses of frequently used service locations (e.g., a gym, grocery store, mall, local airport, sports arena or stadium, concert venue, local parks, and the like). In addition, the database 145 can further store promotion data 147 relating to available promotions for entities or establishments.

According to embodiments, the network system 100 can include a recommendation engine 140 to identify appropriate recommendations and promotions for delivery to the user device 190. The recommendation engine 140 can generate recommendation/promotion data 141 that correspond to the identified recommendations and promotions for the user 197. The recommendation engine 140 can determine appropriate recommendations and promotions to deliver to the user device 190 by gathering context information. Such context information can include information related to the service request (e.g., based on service request data 131), information derived from user profile data (e.g., based on user profile data 149), information derived from data received from third-party sources (e.g., based on third-party data 156), and the like.

Based on the context information, the recommendation engine 140 can identify one or more appropriate recommendations and/or promotions to deliver to the user device 195. In some examples, the recommendation engine 140 can retrieve available promotion data 147 from the database 145 that indicate the promotions currently available. Using the context information, the recommendation engine 140 can filter out irrelevant promotions or promotions in which the user would have little interest. For instance, if the service request data 131 indicates that the service request 199 is to be fulfilled at approximately 12:00 PM, the recommendation engine 140 can filter out promotions relating to happy hours offered at nearby bars that are only valid between 5:00 PM and 7:00 PM. Similarly, the recommendation engine 140 can filter out recommendations for lunch-only restaurants based on the service request 199 indicating a service time of 8:00 PM.

In some examples, the recommendation engine 140 can determine appropriate recommendations or promotions based on data corresponding to other users of the network service. For instance, in the context of an on-demand transportation service, the service request 199 of the user 197 may include an intermediary stop(s) to pick up a companion(s) of the user 197 on a trip to the service location. The service request 199 may identify the companion(s) as user(s) of the network service. For example, the user 197 may select the companion(s) from a list of contacts or known users within the user application 196. Thus, the recommendation engine 140 can retrieve profile data pertaining to the companion(s) from the database 145 indicating preferences, past service requests of the companion(s) to determine appropriate promotions to generate for the user 197 and the companion(s) on this particular occasion. In addition, the recommendation engine 140 can determine recommendations or promotions based on preferences of other users determined to be similar in profile to user 197. For instance, data relating to other users who share one or more characteristics (e.g., same area of residence, similar user preferences, similar past service requests, etc.) with user 197 can be used to determine appropriate recommendations and promotions for user 197.

In various aspects, the recommendation engine 140 can further determine a delivery time associated with a promotion or recommendation. For instance, upon determining that the intended destination of the user 197 is a restaurant, the recommendation engine 140 can determine one or more additional points of interest for the user 197 such as nearby bars, movie theaters, and the like. Instead of immediately transmitting promotions or recommendations directed to such other points of interest, the recommendation engine 140 can determine a delivery time for such promotions and recommendations such that the promotions and recommendations can be conveyed to the user 197 at a time when the user 197 can take action on them. In this example, the recommendation engine 140 can determine the delivery time based on an estimate of when the user 197 is likely to complete his or her visit at the restaurant. Such a determination can be based on historical data relating to other users of the network service (e.g., time of arrival at the restaurant and time of service request for leaving the restaurant) or data from the entity itself (e.g., data from the restaurant indicating an average amount of time spent by patrons). In this manner, the recommendation engine 140 can deliver promotions and recommendations to the user 197 when such promotions and recommendations are particularly relevant to the user 197.

The recommendation engine 140 can receive third party data 156 from third party services 155 via a third-party interface 120. The third party data 156 can include data from a calendar service (e.g., a web-based calendar, corporate email and calendar system, etc.), a reservation or booking service (e.g., restaurant reservation service, event booking service), a financial transactions service (e.g., credit card network, credit or debit transaction processors, credit or debit card issuers, etc.), data from entities (e.g., restaurants, bars, venues, etc.), and the like. The recommendation engine 140 can utilize third party data 156 to determine context information. For instance, using data received from a third party calendar service, the recommendation engine 140 can determine an upcoming event or appointment for the user. Based on such information, the recommendation engine 140 can determine context information such as both an intended destination as well as a purpose in association with the user's service request 199. Similarly, based on data received from a third party reservation system, the recommendation engine 140 can determine that the user has a reservation at an establishment or entity located near the service location. Thus, the recommendation engine 140 can determine the establishment or entity holding the user's reservation as the intended destination.

In certain implementations, promotions conveyed to the user by the network system (e.g., via promotional content data 151 transmitted to the user device 195) can comprise one or more requirements. For example, certain promotions can require that the user 197 make a certain number of transactions or meet a certain spending requirement at a specific entity(ies) in order to receive certain benefits or discounts. The recommendation engine 140 can determine the user's completion of such requirements based on third party data 156 received from one or more third party services 155. For instance, the third party data 156 can be received from a financial transactions service indicating the user's purchases at the entity in order to determine whether the user 197 satisfied the one or more requirements. In some examples, the third party data 156 may be directly received from the entity itself (e.g., transmitted by a point of sale terminal at the entity).

If the user 197 fulfills the requirements of a promotion, the recommendation engine 140 can determine one or more actions 142 as part of the reward to the user 197 for meeting the requirements of the promotion. The one or more actions 142 can be related to the network service and can be transmitted to the selection engine 130. In one example, the one or more actions 142 comprise a discount related to a future service request. For example, an entity such as a bar can reward the user 197 for completing the requirements of a promotion with a discounted or free on-demand transport service to the user's 197 home (e.g., as stored in the user's profile). Such a discount or reward can have an expiration associated therewith. Furthermore, the discount or reward may be applied only in specific situations (e.g., only valid for service locations within a certain distance of the user's home address).

In various implementations, the network system 100 can include a content engine 150 that generates promotional content data 151 for presenting one or more user interface features on the user device 195 relating to the promotions or recommendations selected for the user 197. The generation of promotional content data 151 can be based on recommendation/promotional data 141 received from the recommendation engine 140. The promotional content data 151 can be transmitted to the user device 195 via user device interface 125 and the network 180. The user interface features can enable the user 197 to view the promotions and/or recommendations selected by the recommendation engine 140 based on context and other information. In some examples, the content data 151 can include data to cause to the user device 195 to display push notifications notifying the user 197 of the promotions or recommendations at the appropriate time.

Methodology

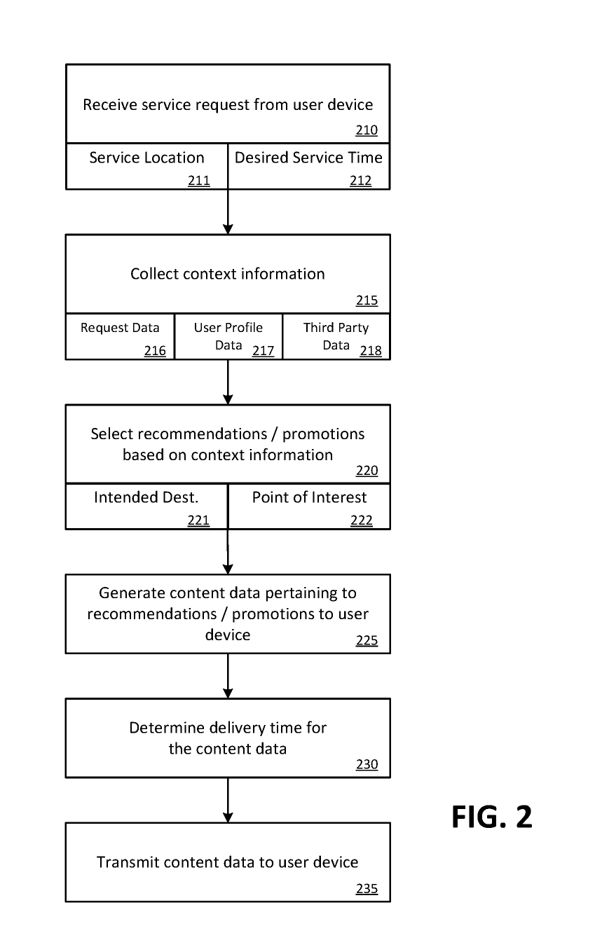

FIG. 2 is a flow chart describing an example method of operating an exemplary network system having a recommendation engine, according to examples described herein. In the below discussion of FIG. 2, reference may be made to features and examples shown and described with respect to FIG. 1. For instance, the process described with respect to FIG. 2 may be performed by an example network system and recommendation engine such as the one shown and described with respect to FIG. 1.

Referring to FIG. 2, a network system (e.g., network system 100 of FIG. 1) can receive a service request from a user device (e.g., service request 199 from user device 195 of FIG. 1) operated by a user over a network (210). The service request can be transmitted by the user device in response to user interactions with a user application executing on the user device (e.g., opening or launching the user application, selecting or activating a user interface feature, etc.). The request received from the user device can include a service location 211 and/or a desired service time 212. The service location 211 can be entered by the user through the user application (e.g., by entering an address, by searching a name or location, by selecting on an interactive map, etc.), or auto-populated based on historical data pertaining to the user (e.g., a home location, a work location, a favorite location, etc.). The desired service time 212 can correspond to a desired time at which the requested service is to be fulfilled (e.g., a time at which the service provider is to rendezvous with the requesting user). By selecting a desired service time 212, the requesting user can schedule a service to be performed at a specific time; otherwise, the network system can immediately begin to fulfill the requested service. In addition, the service request can indicate a start location.

Upon receiving the service request, the recommendation engine of the network system can collect context information for the requested service (215). Context information can include information derived from the request data (216), user profile data (217), and third-party data (218). The request data can indicate context information such as service location, time of service, class of service, etc. Context information derived from user profile data can include information regarding user preferences, past service requests of the user, and user demographics. Third-party data can include data received from a calendar service, data received from a reservation service, transaction data of the user received from a financial service or a payment processing service.

The recommendation engine can be configured to select promotions or generate recommendations based on the collected context information (220). There can be a plurality of available promotions stored within a database accessible to or managed by the network system and/or the recommendation engine. Thus, based on context information associated with the user and the user's request for service, the recommendation engine can select one or more appropriate or suitable promotions or generate relevant recommendations to the user based on context information. The recommendation engine can perform step 220 by utilizing machine-learned models (e.g., neural networks, decision trees, etc.) generated based on historical data of users of the network service. The machine-learned models can generate outputs that indicate user preferences or typical user behavior given a particular set of context information. Thus, based on context information collected for a given service request of a requesting user, the recommendation engine can select promotions or generate recommendations for the requesting user based on outputs from the machine-learned models that take into account past behaviors and preferences of users having similar context information. In this manner, the recommendations engine can utilize the most relevant historical data (e.g., similar users in similar circumstances as indicated by the context information) in selecting relevant promotions or generating suitable recommendations for the requesting user. In addition, in utilizing historical data of the networks service in selecting promotions and generating recommendations, the recommendation engine can base its decisions on historical data of other users of the network service that are determined to be similar to the requesting user (e.g., based on demographic information, based on past service requests, etc.). In selecting suitable promotions and generating relevant recommendations, the recommendation engine can determine an intended destination (221) and/or an additional point of interest (222) based on the context information.

According to embodiments, the network system can generate content data pertaining to the selected recommendations and/or promotions to the user device (225). Content data can include data to cause the receiving user device to display one or more user interface features relating to the selected promotions or generated recommendations. The one or more user interface features can be displayed within the user application associated with the network service. For instance, promotions and recommendations can be displayed within a user application executing on the user device that is used by the user to request and manage the network service. In addition, the network system can transmit data to the user device to cause the user device to display a push notification relating to the promotions selected for the requesting user.

In some examples, the recommendation engine can further determine a delivery time for the generated content data (230). The delivery time can be determined based on context information and the selected promotion(s). For instance, if a promotion offered by an entity located near the service location of a transport request is selected, the recommendation engine can determine a delivery time of the content data pertaining to the selected promotion based on service progress information such as the requesting user's ETA at the service location. In doing so, the network system can transmit content data pertaining to the promotion at approximately the same time as the user arrives at the service location. In this manner, the promotion can be conveyed to the user at a suitable time for the user to act on the promotion. Subsequently, the network system transmits the generated content data to the user device at the determined delivery time (235).

User Device

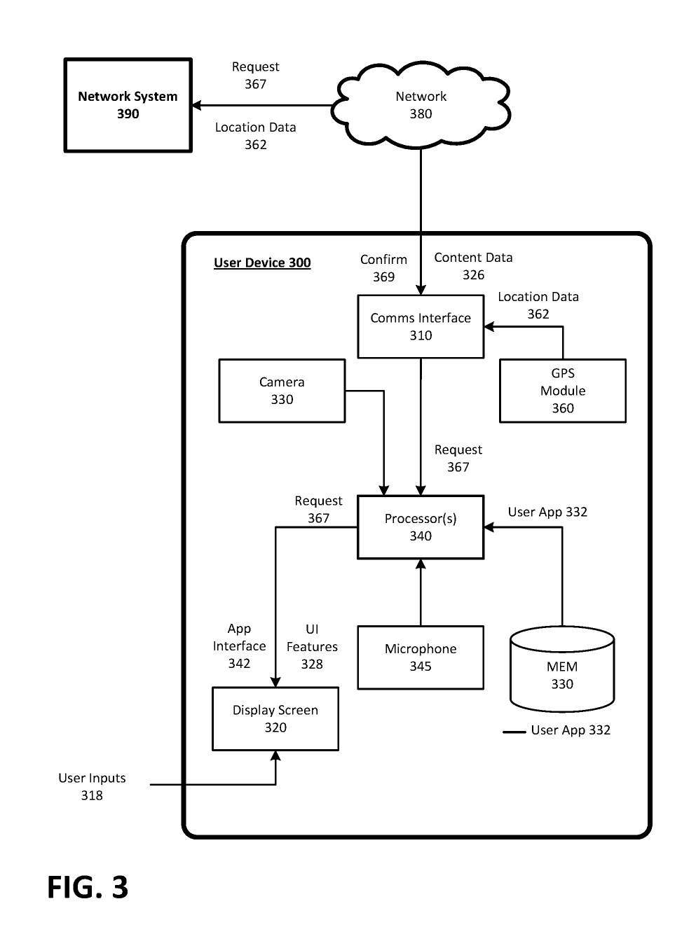

FIG. 3 is a block diagram illustrating an example user device executing and operating a designated user application for communicating with a network service, according to examples described herein. In many implementations, the user device 300 can comprise a mobile computing device, such as a smartphone, tablet computer, laptop computer, VR or AR headset device, and the like. As such, the user device 300 can include typical telephony features such as a microphone 345, a camera 330, and a communication interface 310 to communicate with external entities using any number of wireless communication protocols. In certain aspects, the user device 300 can store a designated application (e.g., a user app 332) in a local memory 330. In variations, the memory 330 can store additional applications executable by one or more processors 340 of the user device 300, enabling access and interaction with one or more host servers over one or more networks 380.

In response to a user input 318, the user app 332 can be executed by a processor 340, which can cause an app interface 342 to be generated on a display screen 320 of the user device 300. The app interface 342 can enable the user to, for example, view available items offered by nearby entities. In various implementations, the app interface 342 can further enable the user to enter or select a service location (e.g., by entering an address, performing a search, or selecting on an interactive map). Furthermore, the app interface 342 can display dynamically determined values associated with the available items. The user can generate a request 367 via user inputs 318 provided on the app interface 342. For example, the user can select one or more items from the available items in requesting the network service. In some examples, the app interface 342 can display one or more suggested or recommended items that are identified by the network system based on information specific to the user (e.g., user profile information).

As provided herein, the user application 332 can further enable a communication link with a network system 390 over the network 380, such as the network system 100 as shown and described with respect to FIG. 1. The processor 340 can generate user interface features 328 (e.g., map, request status, content cards, etc.) using content data 326 received from the network system 390 over network 380. Furthermore, as discussed herein, the user application 332 can enable the network system 390 to cause the generated user interface 328 to be displayed on the application interface 342.

The processor 340 can transmit the requests 367 via a communications interface 310 to the backend network system 390 over a network 380. In response, the user device 300 can receive a confirmation 369 from the network system 390 indicating the selected service provider that will service the request 367. In various examples, the user device 300 can further include a GPS module 360, which can provide location data 362 indicating the current location of the requesting user to the network system 390 to, for example, establish the service location.

According to embodiments, the app interface 342 can further display user interface features indicating or representing a current status of the request for service. For instance, the app interface 342 can display a progress bar indicating the current status of the user's request. The app interface 342 can also display useful information such as an estimated time of arrival of the selected service provider at the service location. In addition, the user can enter, via the app interface 342, information that may be relevant to the selected service provider such as a building entry access code, an intercom number or code, a contact phone number of the user, a cross-street, etc.

Hardware Diagram

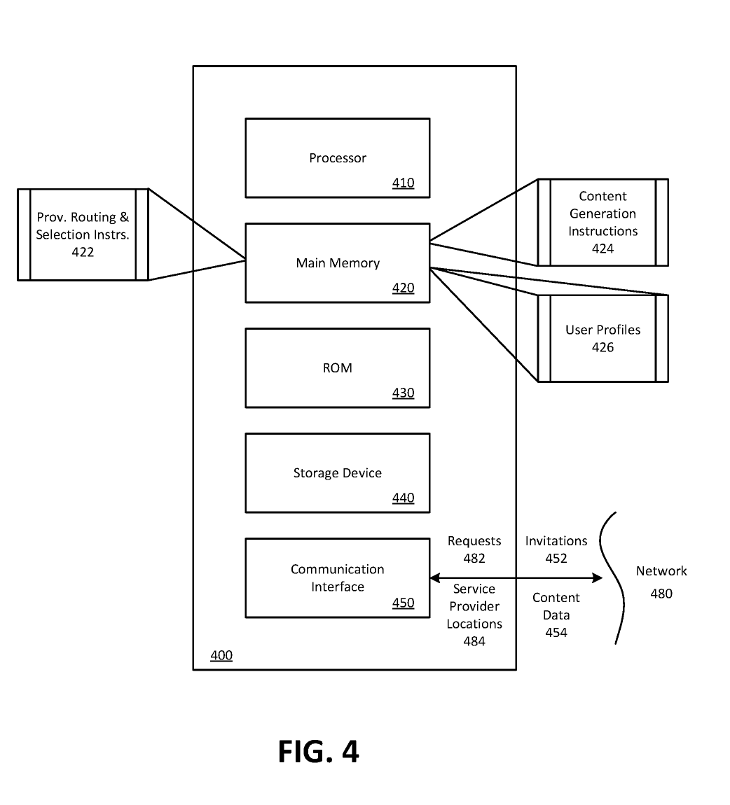

FIG. 4 is a block diagram that illustrates a computer system upon which examples described herein may be implemented. A computer system 400 can be implemented on, for example, a server or combination of servers. For example, the computer system 400 may be implemented as part of a network service, such as described in FIGS. 1 through 4. In the context of FIG. 1, the network system 100 may be implemented using a computer system 400 such as described by FIG. 4. The network system 100 and may also be implemented using a combination of multiple computer systems as described in connection with FIG. 4.

In one implementation, the computer system 400 includes processing resources 410, a main memory 420, a read-only memory (ROM) 430, a storage device 440, and a communication interface 450. The computer system 400 includes at least one processor 410 for processing information stored in the main memory 420, such as provided by a random access memory (RAM) or other dynamic storage device, for storing information and instructions which are executable by the processor 410. The main memory 420 also may be used for storing temporary variables or other intermediate information during execution of instructions to be executed by the processor 410. The computer system 400 may also include the ROM 430 or other static storage device for storing static information and instructions for the processor 410. A storage device 440, such as a magnetic disk or optical disk, is provided for storing information and instructions.

The communication interface 450 enables the computer system 400 to communicate with one or more networks 480 (e.g., cellular network) through use of the network link (wireless or wired). Using the network link, the computer system 400 can communicate with one or more computing devices, one or more servers, one or more databases, and/or one or more self-driving vehicles. In accordance with examples, the computer system 400 receives requests 482 from mobile computing devices of individual users. The executable instructions stored in the memory 430 can include provider routing and selection instructions 422, which the processor 410 executes to determine an optimal route and select a service provider to service the request 482.

The executable instructions stored in the memory 420 can also include content generation instructions 424, which enable the computer system 400 to access user profiles 426 and other user information in order to select and/or generate user content 454 for display on the user devices. As described throughout, content data 454 can be generated based on promotions or recommendations selected or generated based on context information relating to the user and/or the user's request for service.

By way of example, the instructions and data stored in the memory 420 can be executed by the processor 410 to implement an example network system 100 of FIG. 1. In performing the operations, the processor 410 can receive requests 482 and service provider locations 484, and submit invitation messages 452 to facilitate the servicing of the requests 482. The processor 410 is configured with software and/or other logic to perform one or more processes, steps and other functions described with implementations, such as described by FIGS. 1 to 4, and elsewhere in the present application.

Examples described herein are related to the use of the computer system 400 for implementing the techniques described herein. According to one example, those techniques are performed by the computer system 400 in response to the processor 410 executing one or more sequences of one or more instructions contained in the main memory 420. Such instructions may be read into the main memory 420 from another machine-readable medium, such as the storage device 440. Execution of the sequences of instructions contained in the main memory 420 causes the processor 410 to perform the process steps described herein. In alternative implementations, hard-wired circuitry may be used in place of or in combination with software instructions to implement examples described herein. Thus, the examples described are not limited to any specific combination of hardware circuitry and software.

It is contemplated for examples described herein to extend to individual elements and concepts described herein, independently of other concepts, ideas or systems, as well as for examples to include combinations of elements recited anywhere in this application. Although examples are described in detail herein with reference to the accompanying drawings, it is to be understood that the concepts are not limited to those precise examples. As such, many modifications and variations will be apparent to practitioners skilled in this art. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude claiming rights to such combinations.

What is claimed is:

1. A network system that manages a service over a given geographic region, the network system comprising:
one or more processors; and
one or more memory resources storing instructions that, when executed by the one or more processors, cause the network system to:
receive, from a user device, request data corresponding to a request for the service from the user device operated by the user, the request data indicating a service location for the requested service;
select, based on one or more sets of context information associated with the user and the request data, one or more promotions for the user from a plurality of promotions, wherein the one or more sets of context information includes the service location and information derived from a user profile of the user;
generate content data pertaining to the one or more promotions; and
transmit, to the user device, the content data to cause the user device to display one or more selectable user interface features regarding the one or more promotions.

2. The network system of claim 1, wherein the one or more sets of context information further comprises a time of service associated with the request for the service.

3. The network system of claim 1, wherein the one or more sets of context information further comprises a class of service indicated by the request data.

4. The network system of claim 1, wherein the one or more sets of context information further comprises transaction data associated with the user received from a third-party source.

5. The network system of claim 1, wherein the one or more sets of context information further comprises data relating to one or more appointments of the user received from a calendar service.

6. The network system of claim 1, wherein the one or more sets of context information further comprises data pertaining to the user received from a social networking service.

7. The network system of claim 1, wherein the one or more sets of context information further comprises a start location associated with the request for service.

8. The network system of claim 1,
wherein the request data further indicates an intermediate location associated with a second user of the network service; and
wherein the one or more sets of context information further comprises user profile data of the second user.

9. The network system of claim 1, wherein, to select one or more promotions, the executed instructions further cause the network system to:
determine, based on the one or more sets of context information, an intended destination or an additional point of interest for the user in connection with the service request;
identify a promotion associated with the intended destination or the additional point of interest from the plurality of promotions; and
select the one or more promotions so as to include the promotion associated with the intended destination or the additional point of interest.

10. The network system of claim 9, wherein the determining of the intended destination is based on the service location.

11. The network system of claim 9, wherein, to determine the intended destination, the executed instructions further cause the network system to:
receive transaction data associated with the user, the transaction data indicating a time of transaction and an identification of a place of transaction; and
determine the intended destination to be the place of transaction based on analyses of: (i) the place of transaction and the service location, and (ii) the time of transaction with a time associated with the service request.

12. The network system of claim 9, wherein the determining of the additional point of interest is based on the intended destination.

13. The network system of claim 9, wherein the determining of the additional point of interest is based on historical data associated with one or more other users of the network service.

14. The network system of claim 1, wherein the executed instructions further cause the network system to:
determine a transmission time for a first set of data of the content data, the first set of data pertaining to a first promotion of the one or more promotions;
wherein determining the transmission time is based on: (i) information relating to a first entity associated with the first promotion, and (ii) the intended destination;
transmit, to the user device, the first set of content data at the determined transmission time.

15. The network system of claim 1, wherein the executed instructions further cause the network system to transmit data to the user device to cause the user device to display a push notification regarding the one or more promotions.

16. The network system of claim 1, wherein transmitting the content data further comprises transmitting the content data to the user device to cause the user device to display one or more user interface features regarding the one or more promotions within a user application executing on the user device, the user application being configured to cause the user device to transmit the request data.

17. The network system of claim 1,
wherein a first promotion of the one or more promotions comprises an eligibility requirement; and
wherein the executed instructions further cause the network system to:
receive transaction data associated with the user;
determine, based on the transaction data, whether the user fulfilled the eligibility requirement of the first promotion.

18. The network system of claim 1,
wherein a first promotion of the one or more promotions comprises an eligibility requirement, the first promotion being associated with a first entity; and
wherein the executed instructions further cause the network system to:
receive data from the first entity;
determine, based on data received from the first entity, whether the user fulfilled the eligibility requirement of the first promotion.

19. A computer-implemented method of managing a service, the method being performed by a network system comprising a and comprising:
receiving, from a user device, request data corresponding to a request for the service from the user device operated by the user, the request data indicating a service location for the requested service;
selecting, based on one or more sets of context information associated with the user and the request data, one or more promotions for the user from a plurality of promotions, wherein the one or more sets of context information includes the service location and information derived from a user profile of the user;
generating content data pertaining to the one or more promotions; and
transmitting, to the user device, the content data to cause the user device to display one or more selectable user interface features regarding the one or more promotions.

20. A non-transitory computer-readable medium storing instructions that, when executed by one or more processors of a network system, cause the network system to:
receive, from a user device, request data corresponding to a request for a service from the user device operated by the user, the request data indicating a service location for the requested service;
select, based on one or more sets of context information associated with the user and the request data, one or more promotions for the user from a plurality of promotions, wherein the one or more sets of context information includes the service location and information derived from a user profile of the user;
generate content data pertaining to the one or more promotions; and
transmit, to the user device, the content data to cause the user device to display one or more selectable user interface features regarding the one or more promotions.
